(19) United States
(12) Patent Application Publication
(10) Pub. No.: US 2010/0080141 A1
(43) Pub. Date: Apr. 1, 2010

(54) Network system, monitoring device, information processing device, information processing method, computer-readable recording medium

(75) Inventor: Kazuhiro Nakamura, Nagoya-shi (JP)

Correspondence Address: OLIFF & BERRIDGE, PLC, P.O. BOX 320850, ALEXANDRIA, VA, 22320-4850, US

(73) Assignee: BROTHER KOGYO KABUSHIKI KAISHA, Nagoya-Shi (JP)

(21) Appl. No.: 12/585,657

(22) Filed: Sep. 21, 2009

(30) Foreign Application Priority Data
Sep. 29, 2008 (JP) 2008-251333

(51) Int. Cl. H04L 12/26

(52) U.S. Cl. 370/252

(57) ABSTRACT

A network system includes plural information processing devices mutually connected through a network.

The network system comprises a monitored device which is one of the plural information processing devices, and a monitoring device which is an information processing device other than the monitored device, and which monitors an operating state of the monitored device.

The network system comprises a replica creating device configured to create a replica of delivery information indicated by list information memorized in a list information memorizing device of the monitoring device, in any one of the information processing devices, when a response message corresponding to a monitor message sent by the monitoring device is not returned from the monitored device to the monitoring device.

### CROSS REFERENCE TO RELATED APPLICATION

The present application claims priority from Japanese Patent Application No. 2008-251333, which was filed on Sep. 29, 2008, the disclosure of which is incorporated herein by reference in its entirety.

### BACKGROUND OF THE INVENTION

1. Field of the Invention

The present invention belongs to a field of a network system, a monitoring device, an information processing device, an information processing method, and a computer-readable recording medium. It particularly belongs to a field of a network system where plural information processing devices are connected through a so-called P2P (Peer-to-Peer) network, an information processing devices that are included in the network system, and the like.

2. Discussion of Related Art

Recently, a content delivery service such as VOD (video on demand) and internet television is prevailing due to prevalence of a so-called broadband line.

Networks of a tree type and a grid type using the above-described P2P network as a new mode alternative to a server client method being a mainstream of delivery mode in a current content delivery service have been paid attention to. In such the P2P network, all terminal devices that participate in the network and receive data delivery are connected through, for example, a network such as the internet. Specifically, these terminal devices are realized by a set top box, a personal computer, or the like that are located every home and connected to the above-mentioned network. Hereinafter, the terminal device is simply referred to as “node”.

In the P2P network, all or part of a processing unit and a memory unit installed in the respective nodes are provided to an entire network, and all the nodes share all loads that are generated by storing, searching, and sending and receiving content data subject to be delivered. Such the configuration enables the P2P network to solve disadvantages of the conventional server client method, that are concentration of access from respective nodes to a server as a delivery source, expensive administration cost of servers or the like. Here, there is a conventional art related to a grid-type network using the P2P network.

### SUMMARY OF THE INVENTION

Although the P2P network has the above-mentioned features, it is fully considered that events such as failure of connection to the network and an power-off operation occur in these nodes, because the node itself sharing storage of content data as mentioned above is realized by, for example, a set top box. Occurrence of such events may cause a problem of suspending delivery of the content data, which are to be stored by the node, into the P2P network.

The present invention is provided in consideration of the above problem, and an object is to provide a network system and the like that are capable of maintaining good conditions of content data delivery in the network system without using, for example, an administration server related to the entire network system.

To solve the above problem, according to the first aspect of the present invention, there is provided a network system including plural information processing devices mutually connected through a network,

the network system, comprising:

a monitored device which is one of the plural information processing devices which memorizes delivery information to be delivered to the plural information processing devices through the network, and

a monitoring device which is an information processing device other than the monitored device, and which monitors an operating state of the monitored device,

wherein the monitored device comprises:

a responding device configured to return a response message including at least list information indicative of the delivery information memorized in the monitored device, to the monitoring device which has sent a monitor message, when the monitor message is sent from the monitoring device, and

the monitoring devices comprises:

a monitor message sending device configured to send the monitor message at a preset timing to the monitored device monitored by the monitoring device;

a list information memorizing device configured to extract the list information included in the response message from the response message, and memorize it, when the response message corresponding to the monitor message thus sent is returned from the monitored device; and

the network system comprises:

a replica creating device configured to create a replica of the delivery information indicated by the list information memorized in the list information memorizing device, in any one of the information processing devices, when the response message corresponding to the monitor message thus sent is not returned from the monitored device to the monitoring device.

### BRIEF DESCRIPTION OF THE DRAWINGS

FIG. 1 is a view showing an example of a mutual monitoring state in a delivery system according to an embodiment.

FIG. 2 is a block diagram showing a schematic configuration of a node according to the first embodiment.

FIG. 3 is a view (I) showing an example of an action of respective monitoring nodes and monitored nodes according to the first specific example of the first embodiment, wherein FIG. 3A is a first view exemplifying the action, and FIG. 3B is a second view exemplifying the action.

FIG. 4 is a view (II) showing an example of an action of respective monitoring nodes and monitored nodes according to the first specific example of the first embodiment, wherein FIG. 4A is a third view exemplifying the action, and FIG. 4B is a fourth view exemplifying the action.

FIG. 5 is a view (I) showing an example of an action of respective monitoring nodes and monitored nodes according to the second specific example of the first embodiment, wherein FIG. 5A is a first view exemplifying the action, and FIG. 5B is a second view exemplifying the action.

FIG. 6 is a view (II) showing an example of an action of respective monitoring nodes and monitored nodes according to the second specific example of the first embodiment, wherein FIG. 6A is a third view exemplifying the action, and FIG. 6B is a fourth view exemplifying the action.

FIG. 7 is a flowchart showing a specific action respectively in the monitoring nodes according to the first embodiment.

FIG. 8 is a flowchart showing a specific action respectively in the monitored node and the corresponding node respectively according to the first embodiment, wherein FIG. 8A and FIG. 8B are flowcharts showing the specific action in the monitored node, and FIG. 8C is a flowchart showing a specific action in the corresponding node.

FIG. 9 is a view (I) showing an example of an action respectively in monitoring nodes and monitored nodes according to a specific example of the second embodiment, wherein FIG. 9A is a first view exemplifying the action, and FIG. 9B is a second view exemplifying the action.

FIG. 10 is a view (II) showing an example of an action respectively in monitoring nodes and monitored nodes according to a specific example of the second embodiment, wherein FIG. 10A is a third view exemplifying the action, and FIG. 10B is a fourth view exemplifying the action.

FIG. 11 is a flowchart showing a specific action respectively in monitoring node and corresponding node according to the second embodiment, wherein FIG. 11A is a flowchart showing a specific action in the monitoring node, and FIG. 11B is a flowchart showing a specific action in the corresponding node.

### DESCRIPTION OF THE PREFERRED EMBODIMENTS

Hereinafter, embodiments of the present invention will be described based on figures. Here, the embodiments described below are embodiments in a case where the present, invention is applied to a P2P network system. Here, the node related to the present invention is referred to as “node device”.

### (I) Outline Configuration of P2P Network System

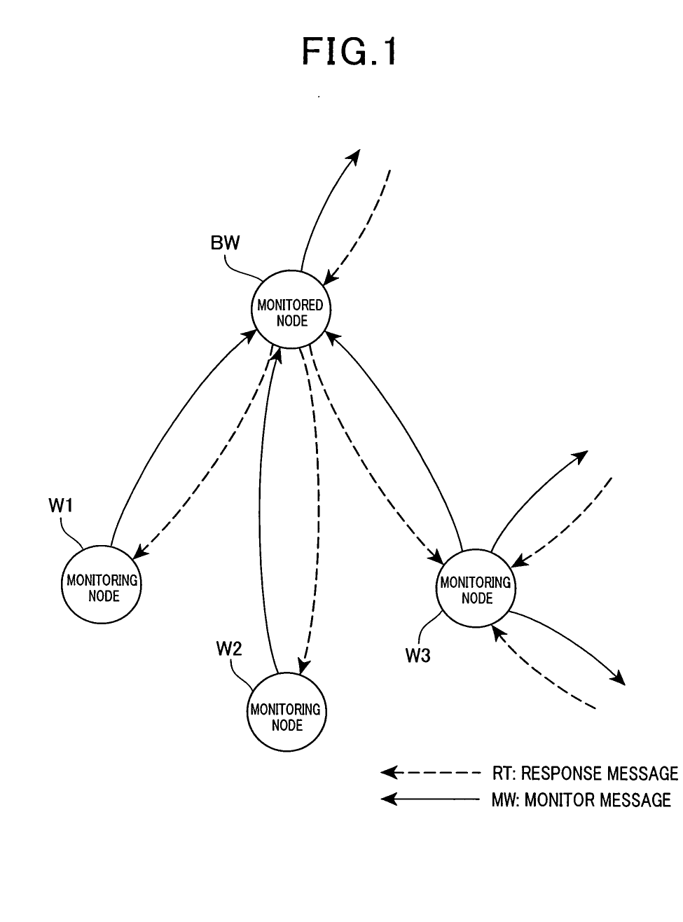

First, with reference to FIG. 1, outline configuration of a P2P network system (hereinafter the P2P network system is simply referred to as “delivery system”) according to the first embodiment is described. Here FIG. 1 is a view exemplifying a state of mutual monitoring in the delivery system according to the embodiment.

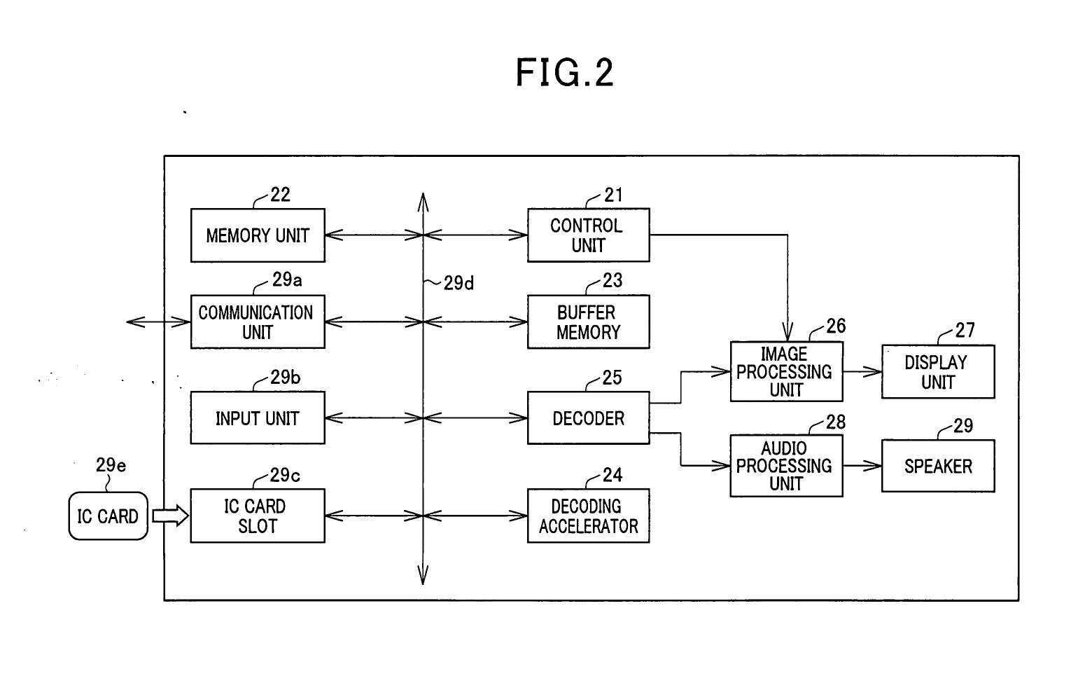

The delivery system according to the first embodiment is a delivery system where plural nodes are connected, as exemplified in, for example, FIGS. 1 and 2 and Paragraphs [0037] to [0053] in the above Patent Document 1.

In this configuration, respective nodes are connected in such a manner that they can mutually give and receive data or the like through a physical network, similarly to the node device 1 in the content delivery system described in the above Patent Document 1.

In a case where a new node participates in the delivery system, the node sends a participation request message for the participation to an already participating node being a connection destination at the time of newly participating in the node. Here, as a method of selecting the already participating node, it is possible to use, for example, a method of searching a node that is regularly connected to the delivery system (Vide Paragraph [0046] of Patent Document 1).

On the other hand, in the delivery system, the content to be delivered to respective nodes is input into the delivery system from a so-called content input server. This content input server is a server that is managed by, for example, a manager of the delivery system. Such the content input server inputs content data corresponding to a new content into the delivery system so that the content data can be delivered to respective nodes participating in the delivery system. More specifically, the content input server makes the above-described content data memorized in the content node being a node in the delivery system. Accordingly, the content node publicizes the content corresponding to thus memorized content data to the other nodes in the delivery system. More specifically, a publishing method in this case may be referred to, for example, description in Paragraphs [0070] and [0071] of the above Patent Document 1.

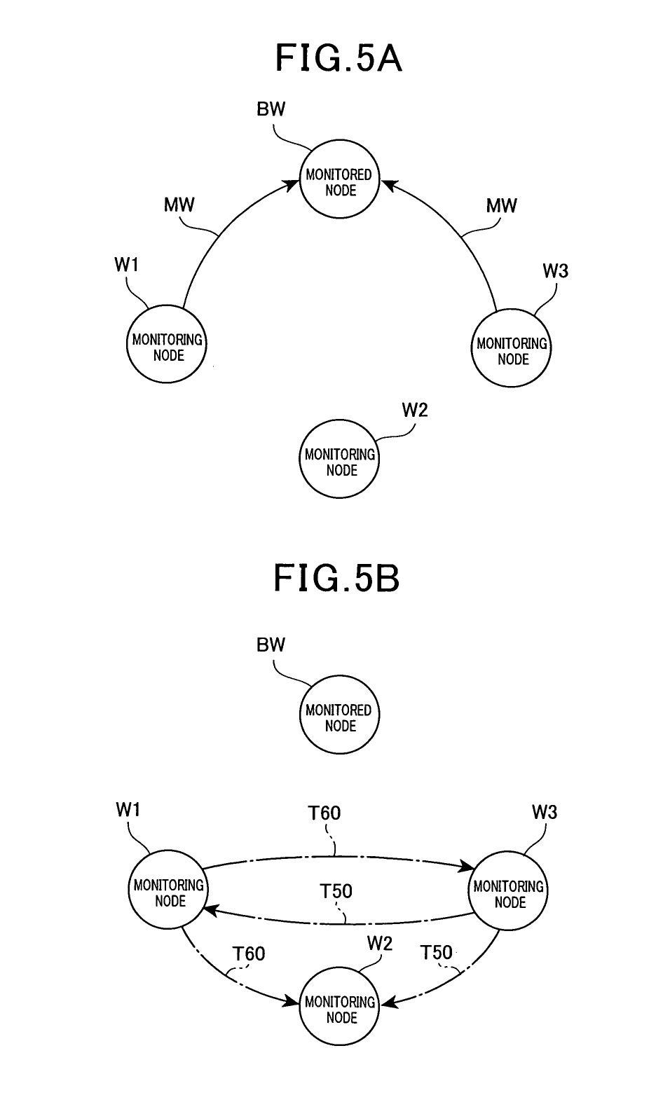

Further, respective nodes participating in the delivery system search a desired content in the delivery system, for example, using the so-called “distributed hash table” described in FIGS. 2 to 4 and Paragraphs [0037] to [0061] in the above Patent Document 1, and by a method described in FIG. 5 and Paragraphs [0062] to [0069] in the above Patent Document 1 as well. Then, the content data corresponding to the content discovered as a result of the search are acquired (downloaded) from the content node storing the content data and reproduced.

Next, a configuration for functional mutual monitor among plural nodes according to the first embodiment is exemplified and described with reference to FIG. 1.

In the configuration, provided that a certain node is a monitored node, the monitored node is regularly monitored in the operating state by a monitoring node being another node. There exist three such monitoring nodes with respect to a single monitored node in the delivery system according to the embodiment.

In other words, in the delivery system according to the first embodiment as exemplified in FIG. 1, three units of monitoring nodes W1 to W3 regularly monitor an operating state of a single monitored node BW. In this case, the monitored node BW memorizes identification information (e.g. IP address of respective monitoring nodes W1 to W3) for respectively identifying the monitoring nodes W1 to W3 to monitor it on the delivery system. The respective monitoring nodes W1 to W3 respectively send monitor message MW to the monitored node BW through a network in the preset time respectively. IP address of the monitoring node W being a sending source thereof is described in the monitor message MW. Hereinafter, the monitoring nodes W1 to W3 in block are simply referred to as “monitoring node W”.

On the other hand, every time the monitored node BW receives a monitor message MW, the monitored node BW updates an IP address of the monitoring node W memorized by the monitored node BW by using the IP address of the monitoring node W included therein.

Further, the monitored node BW returns a response message RT to respective monitoring nodes W1 to W3 in correspondence with the received monitor message MW. An IP address of another monitoring node W that monitors the monitored node BW is described in this response message RT. Specifically, in the response message RT in correspondence with the monitor message MW sent from, for example, a monitoring node W1, an IP address of a monitoring node W (i.e. monitoring nodes W2 and W3 in the case exemplified in FIG. 1) other than the monitoring node W1 is included. In addition, in a case where the monitored node BW is the above-described content node, a list of content IDs of the content memorized at the moment by the monitored node BW being the content node is included in the response message RT.

According to the above configuration, a single monitored node BM is regularly monitored by three units of monitoring nodes W1 to W3. Accordingly, in a case where there occur troubles such as power-off and connection failure to a network in the monitored node BM, any of the monitoring nodes W1 to W3 detects the trouble and starts a complementary action for complementing the trouble in thus detected monitoring node W. Here, specifically, as the complementary action, in a case where for example the monitored node BW is the above-described content node, there is considered a process or the like where the content data memorized therein is replicated to any other node.

Here, for example, in a case where the above-described troubles such as power-off and connection failure to the network occur in a given monitoring node W1, the above-described monitor message MW is not sent to the monitored node BW in turn. In this case, the monitored node BW searches new monitoring node W in the delivery system by itself, and sends a monitor request message described later to thus searched monitoring node W so that the monitored node BW is monitored. Accordingly, a single monitored node BW is kept under monitor of a constant number (three in the case of the embodiment) of monitoring nodes W.

Further, as exemplified in FIG. 1, the monitored node BW itself may also function as a monitoring node with respect to the other node. Further a single monitoring node W (e.g. the monitoring node W3 in the case exemplified in FIG. 1) may take a role of monitoring other plural monitored nodes. Further, this configuration of mutual monitoring is already applied by, for example, the present applicant as Japanese Unexamined Patent Application Publication No. 2007-245072.

### (II) First Embodiment

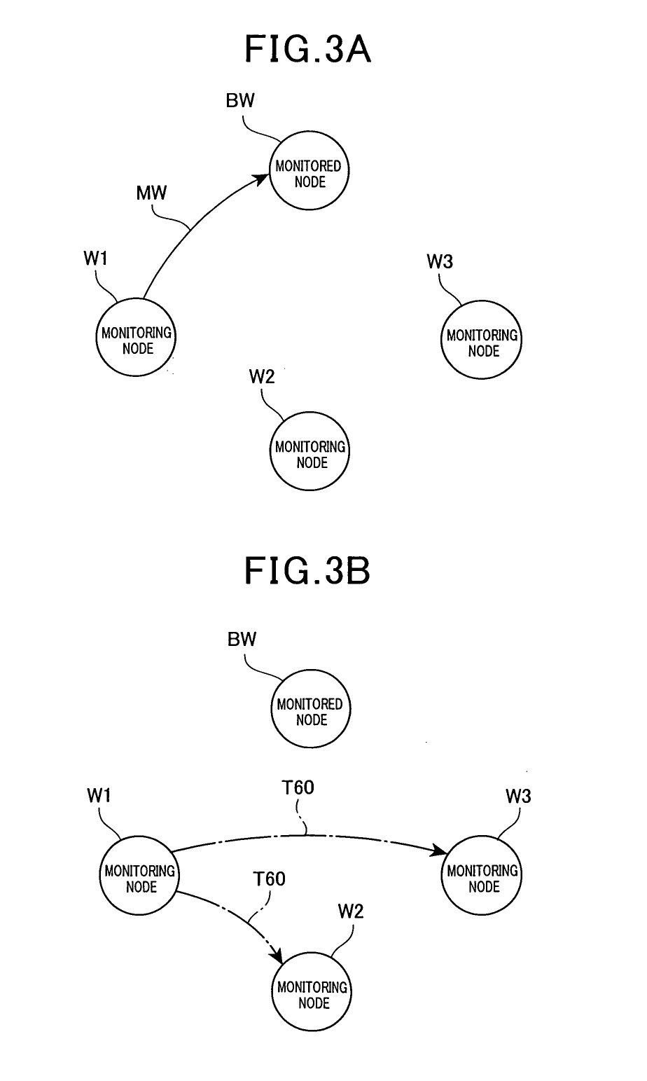

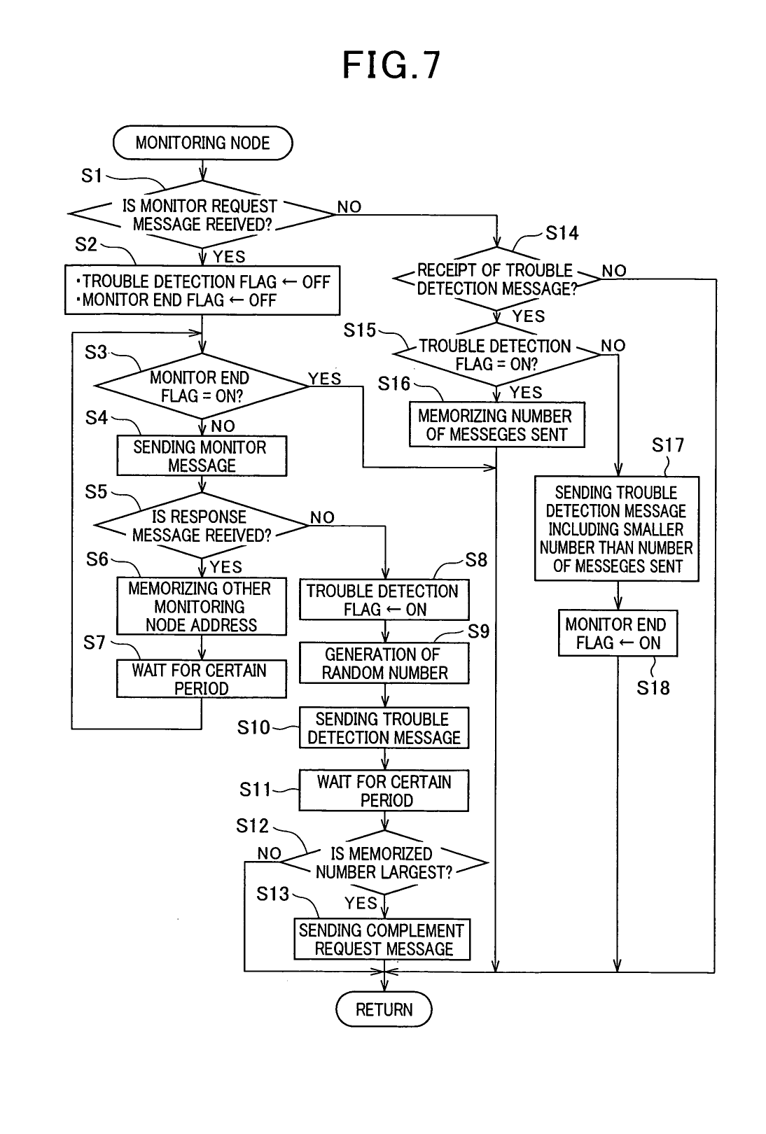

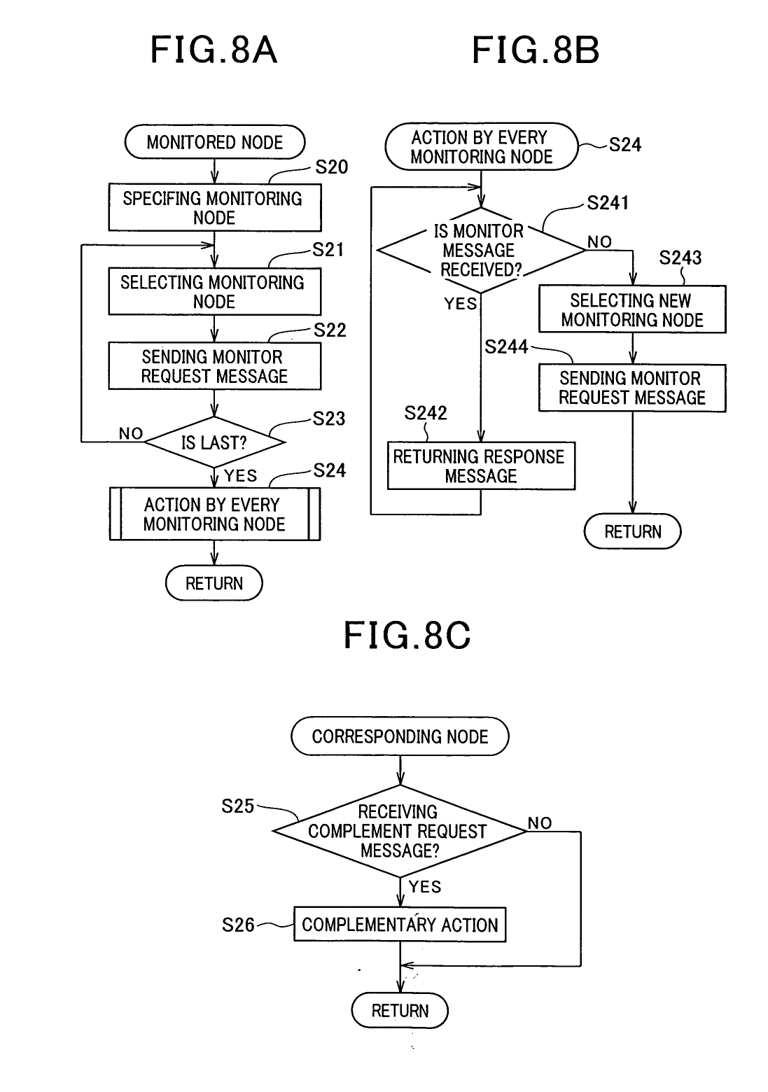

Next, a first embodiment according to the present invention will be described using FIGS. 2 to 8. Here, FIG. 2 is a block diagram showing schematic configuration of a node according to the first embodiment. FIGS. 3 to 6 are views exemplifying an action of respective monitoring nodes W and a monitored node BW according to the first embodiment. FIGS. 7 and 8 are flowcharts showing a specific action in the respective monitoring nodes W and the monitored node BW according to the first embodiment. Here, the respective nodes according to the first embodiment basically include the same detail configuration and basically carry out the same detail action independently.

As shown in FIG. 2, the node 1 according to the first embodiment is configured by including: a control unit 21 as a replica creating device, a searching device, a selecting device, a number generating device, and an extracting device; a memory unit 22 as a list information memorizing device, a delivery information memorizing device, and a number memorizing device; a buffer memory 23; a decoding accelerator 24; a decoder 25; an image processing unit 26; a display unit 27; an audio processing unit 28; a speaker 29; a communication unit 29a as a return device, a monitor message sending device, a replica sending request message sending device, a number sending device, a number responding device, a replica creation request message sending device and a replica creation request message reception device; an input unit 29b; and an IC card slot 29c. These elements are mutually connected through a bus 29d.

Here, the control unit 21 is configured by a CPU having computing function, a RAM for work, a ROM for memorizing various data and programs (including OS (Operating System) and various applications), and the like. The memory unit 22 is configured by an HDD (Hard Disc Drive) and the like for memorizing various data, programs and the like. The buffer memory 23 temporarily accumulates (memorizes) the received content data.

Meanwhile, the decoding accelerator 24 decodes the content data CD thus accumulated in the buffer memory 23 using a decode key. The decoder 25 decodes video data, audio data, and the like included in the decoded content data CD and reproduces (by data stretching or the like). Further, the image processing unit 26 carries out a predetermined image process on thus reproduced video data or the like and outputs as an image signal.

On the other hand, the display unit 27 includes CRT (Cathode Ray Tube), liquid crystal display, and the like, and displays a corresponding image in response to the image signal outputted from the image processing unit 26. The audio processing unit 28 converts thus reproduced audio data into an analog audio signal in use of D/A (digital/analog) conversion, amplifies thus converted signal by an amplifier, and outputs the same. Further, the speaker unit 29 outputs an audio signal outputted from the audio processing unit 28 as a sound wave.

Further the communication unit 29a carries out communication control with other node 1 in the delivery system through the communication line 9. Further, the input unit 29b includes, for example, a mouse, a keyboard, an operation panel or a remote controller, and the like. The input unit 29b outputs to the control unit 21 an instruction signal in response to various instructions from a user (viewer). The IC card slot 29c reads and writes information with respect to an IC card 29e.

Here, the IC card 29e is tamper resistant and is delivered, for example, from an operator of the delivery system according to the embodiment to a user of respective nodes 1. Here, being tamper resistant device that the IC card is provided with tampering measures so that secret data are protected against read by illegal device and are not easily analyzed. Such the IC card 29e is configured by an IC card controller including CPU, a nonvolatile memory of tamper resistant for example EEPROM (Electrical Erasable and Programmable ROM), and the like. The nonvolatile memory memorizes a user ID, a decode key for decoding encoded content data, a digital certificate, and the like.

On the other hand, the buffer memory 23 is configured by a ring buffer memory of, for example, FIFO (First In First Out) format, and temporarily accumulates content data CD received through the communication unit 29a in a memory region indicated by a receiving pointer under the control of the control unit 21.

Here, the control unit 21 integrally controls the entire node 1 by causing CPU therein to read out a program memorized in the memory 22 or the like and to carry out the program, and carries out respective actions according to the embodiment described later. In addition, the control unit 21 receives through the communication unit 29a various messages and plural packets that are sent from the other node 1 thorough the network configuring the delivery system by the above-described distributed hash table and writes them in the buffer memory 23, as a normal action. The control unit 21 reads out various messages and packets that are accumulated (received in the past in a given time) in the buffer memory 23 and further transfers them to the other node 1 through the communication unit 29a based on the above-described distributed hash table. On the other hand, the buffer memory 23 reads out packets accumulated in the memory region of the buffer memory 23 that is indicated by a reproduction pointer, and outputs them to the decoding accelerator 24 and the decoder 25 through the bus 29d.

Here, the above-described program may be downloaded from a predetermined server on the network, or may be recorded in a recording medium such as CD-ROM (Compact disc-ROM) and read through a driver of the recording medium.

Next, a specific example of action according to the first embodiment in the node 1 is exemplified and described using FIGS. 3 to 6.

Here, in the first embodiment described below, in a case where there occur troubles such as the above-described power off in a single monitored node BW, three monitoring nodes W1 to W3 monitoring the operating state of the monitored node BW first carry out mutual communication. Then, one monitoring node W is determined among three monitoring nodes W1 to W3, and only the determined monitoring node W carries out a complementary action for complementing the above-described troubles in the monitored node BW.

Here, the node 1 functioning as the monitoring node W in an action according to the first embodiment nonvolatily memorizes in the memory unit 22 only the number of monitored nodes BW being monitored about operating state, as a set of three pieces of information described below. In other words, the respective monitoring nodes W nonvolatily memorizes in the memory unit 22 only the number of the monitored nodes BW with respect to the monitored node BW being monitored about operating state, as a set of three items “monitor ending flag”, “trouble detection flag” and “number list”.

Then, the monitor ending flag is a flag that is turned “ON” when the monitoring node W ends monitoring the monitored node BW responded by the monitor ending flag and that is turned “OFF” when the monitoring node W newly starts monitoring any one of monitored nodes BW. The trouble detection flag is a flag that is turned “ON” when a trouble detection message described later that the trouble occurs in the monitored node BW responded by the trouble detection flag is sent from the other monitoring node W monitoring the same monitored node BW. On the other hand, the trouble detection flag turned “OFF” when a monitor request message descried later is received from any one of monitored nodes BW. Finally, the number list is a list that memorizes number described later which is sent from the other monitoring node W monitoring the monitored node BW through a network when the trouble occurs in the monitored node BW responded by the number list.

### (A) First Example of First Embodiment

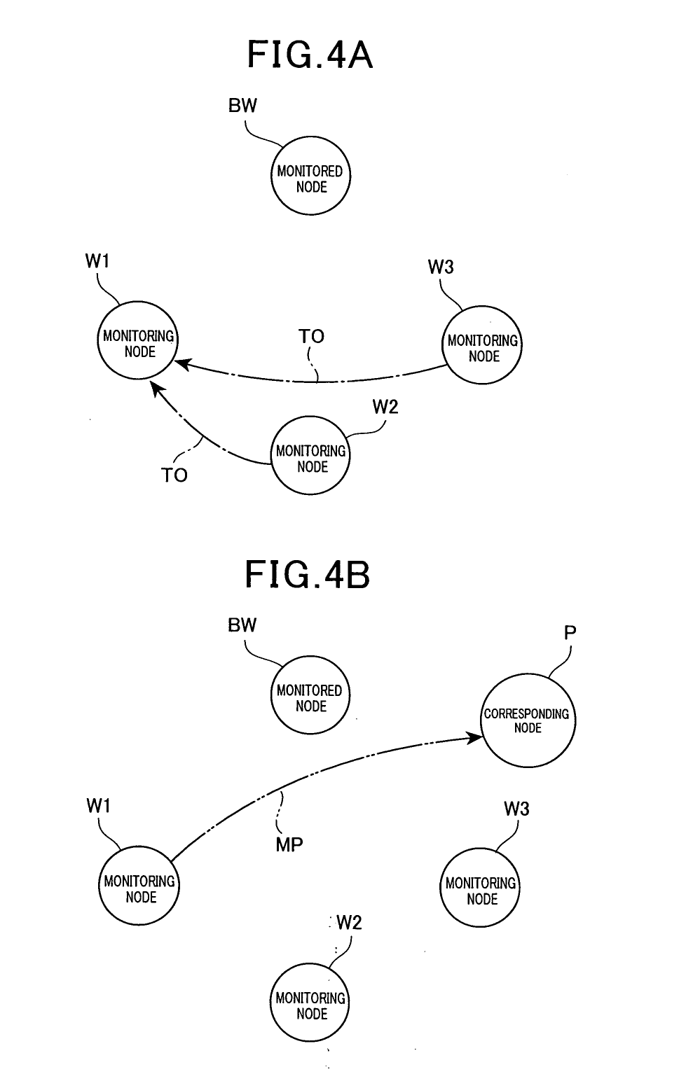

Next, as an first example of the first embodiment, a case where only a monitoring node W being any one of three monitoring nodes W detects a trouble in the monitored node BW is specifically described using FIGS. 3 and 4.

First, as shown in FIG. 3A, in a normal monitoring state described above, it is provided that the respective monitoring nodes W1 to W3 individually and separately monitor an operating state of the monitored node BW. Further it is provided that a response message RT from the monitored node BW to a monitor message MW sent from the monitoring node W1 is not sent. In this case, when the control unit 21 of the monitoring node W1 confirms that the response message RT from the monitored node BW is not sent, the control unit 21 of the monitoring node W1 judges that some trouble occurs in the monitored node BW, and stops monitoring the operating state of the monitored node BW.

Next, the monitoring node W1 judging the “trouble occurrence” causes the control unit 21 to generate random number and memorize it in the memory unit 22. It is provided that thus generated random number is “60”. Accordingly, as shown in FIG. 3B, based on identification information (e.g. the IP address) of the other monitoring node W (the monitoring nodes W2 and W3 in the case exemplified in FIG. 3B that monitors an operating state of the monitored node BW which is included in the response message RT sent from the monitored node BW in an normal operating state, the control unit 21 sends a trouble detection message T60 with respect to the monitored node BW to all of the other monitoring nodes W respectively. This trouble detection message T60 includes information that the monitoring node W1 detects a possibility of trouble occurrence in the monitored node BW, identification information for identifying the monitored node BW itself where the trouble occurs, identification information for identifying the monitoring node W1 itself as a sending source, and the above-described random number “60” generated in the control unit 21 of the monitoring node W1.

Next, the control unit 21 of the other monitoring nodes W2 and W3 receiving the trouble detection message T60 separately and independently generates, in the control unit 21 thereof respectively, random number smaller than the random number (i.e. “60”) that is included in the trouble detection message T60 sent from the monitoring node W1. It is provided that thus generated random number is “0”. Further, the control unit 21 of the monitoring nodes W2 and W3 stops monitoring the operating state of the monitored node BW when receiving the trouble detection message T60 respectively.

Next, as shown in FIG. 4A, based on identification information of the monitoring node W1 itself that is included in the trouble detection message T60 respectively sent from the monitoring node W1, the control unit 21 of the monitoring nodes W2 and W3 sends a trouble detection message T0 as the monitoring nodes W2 and W3 to the monitoring node W1. In the trouble detection messages T0 respectively include information that they are trouble detection messages as the monitoring nodes W2 and W3, identification information for identifying the monitored node BW itself where the trouble occurs, identification information for identifying the monitoring node W2 or W3 itself as a sending source, and the above-described random number “0” generated in the control unit 21 of the monitoring node W2 or W3 respectively. Then, after sending the trouble detection message T0, the control unit 21 of the monitoring nodes W2 and W3 ends monitoring the operating state of the monitored node BW.

Accordingly, the control unit 21 of the monitoring node W1 receiving the trouble detection message T0 from respective monitoring nodes W2 and W3 compares values between the random number that is included in respective trouble detection messages T0 (i.e. “0”) and the random number (“60” included in the trouble detection message T60 and sent) that is memorized in the memory unit 22 of the monitoring node W1 when the own sends the trouble detection message T60. In the case of FIGS. 3 and 4, it is confirmed that the random number (“60”) which the monitoring node W1 itself includes in the trouble detection message T60 of the own and sends is the largest. Therefore, the control unit 21 of the monitoring node W1 generates a complement request message MP that includes a request to complement the trouble occurred in the monitored node BW and identification information of the monitored node BW, and sends this to a corresponding node P previously recognized.

Here, the corresponding node P is any of the nodes 1 participating in the delivery system according to the first embodiment and a node 1 that is recognized, in the respective monitoring nodes W1 to W3, as the node 1 that carries out the complementary action responding to the trouble occurred in the monitored node BW. The corresponding node P carries out the complementary action for the trouble occurred in the monitored node BW as shown below, based on the content of the complement request message MP sent from the monitoring node W1.

Here, as specific example of the above-described complement request message MP for requesting the complementary action in the corresponding node P, the following three examples are considered.

In a first specific example, in a case where the other node 1 memorizing the content data that the monitored node BW having trouble occurrence memorizes in the memory unit 22 thereof is the above-described corresponding node P, it is considered that information that the content data is replicated and sent to the monitoring node W1 is sent to the corresponding node P as the above-described complement request message MP.

Next, in a second specific example, in a case where the other node 1 memorizing the content data that the memorized node BW memorized as similarly to the first specific example is the above-described corresponding node P, it is considered that information that a replica of the content data is sent to the other node 1 selected, for example, in terms of random number in the delivery system is sent to the corresponding node P as the above-described complement request message MP.

In any case of the first specific example or the second specific example, the respective monitoring nodes W1 to W3 are required to keep track of the other node 1 that memorizes the content data memorized in the memory unit 22 of the monitored node BW that is monitored by the own node.

Finally, in the third specific example, the monitoring node W1 first randomly selects the corresponding node P being a sending source of the complement request message MP in the delivery system. It is considered that request to replicate the content data from the other node 1 that memorizes the content data memorized by the monitored node BW and send them to the corresponding node P is sent to thus selected corresponding node P as the above-described complement request message MP.

In this third specific example, not as the first specific example or the second specific example, the monitoring node W1 is not required to keep track of the other node 1 that memorizes the content data memorized in the memory unit 22 of the monitored node BW that is monitored by the own node.

### (B) Second Specific Example of the First Embodiment

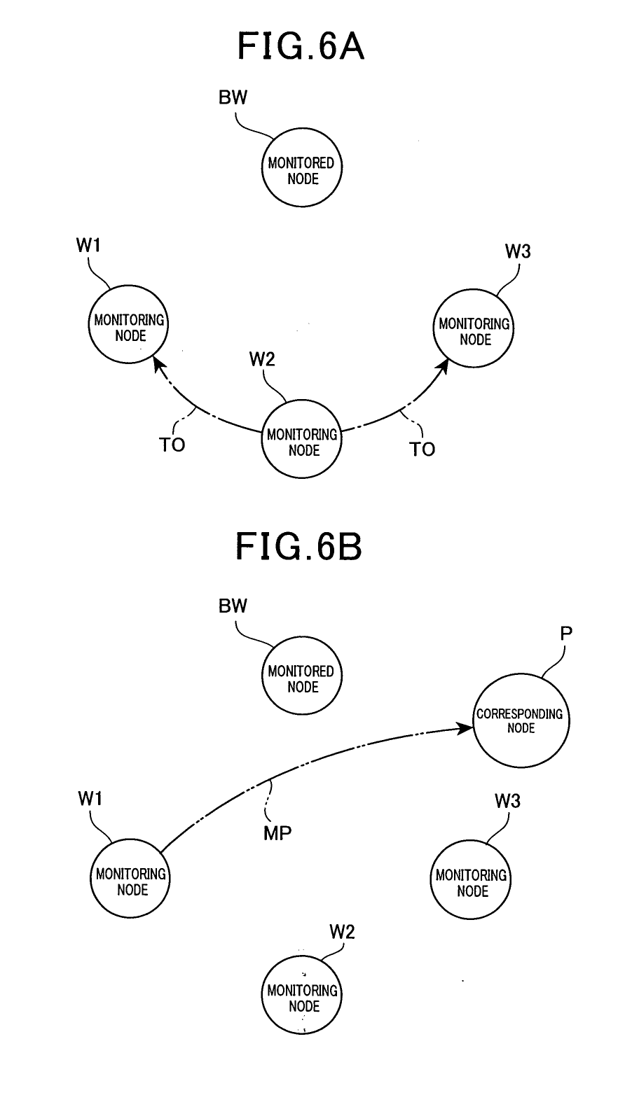

Next, as a second specific example of the first embodiment, there is specifically described about a case where any two monitoring nodes W among three monitoring nodes W detect a trouble at the same time in the monitored node BW using FIGS. 5 and 6.

First, as shown in FIG. 5A, in the normal monitoring state described above, it is provided that the respective monitoring nodes W1 to W3 separately and independently monitor an operating state of the monitored node BW. Further it is recognized at the same time in the monitoring nodes W1 and W3 that a response message RT from the monitored node BW to a monitor message MW sent from the respective monitoring nodes W1 to W3 is not sent. In this case, when the control units 21 of the respective monitoring nodes W1 and W3 separately and independently confirm that the response message RT from the monitored node BW is not sent, the control units 21 of the respective monitoring nodes W1 and W3 judge that some trouble occurs in the monitored node BW, and stop monitoring the operating state of the monitored node BW.

Next, in a manner similar to the first specific example, the monitoring node W1 judging the “trouble occurrence” causes the control unit 21 to generate random number (provided the random number is “60”). As shown in FIG. 5B, the trouble detection message T60 is generated and sent to the other monitoring nodes W2 and W3 respectively.

On the other hand, the monitoring node W3 judging the trouble occurrence in the monitored node BW at the timing same as the monitoring node W1 causes the control unit 21 to generate random number and causes the memory unit 22 to memorize it. Provided that thus generated random number is “50”, as shown in FIG. 5B, in a manner similar to the monitoring node W1, the control unit 21 sends a trouble detection message T50 with respect to the monitored node BW to all other monitoring nodes W, based on identification information of the other monitoring node W (the monitoring nodes W1 and W2 in the case exemplified in FIG. 5B with respect to the monitoring node W3) that monitors an operating state of the monitored node BW. In a manner similar to the trouble message T60, this trouble detection message T50 includes information that the monitoring node W3 detects a possibility of trouble occurrence in the monitored node BW, identification information for identifying the monitored node BW itself where trouble occurs, identification information for identifying the monitoring node W3 itself as a sending source, and the above-described random number “50” generated in the control unit 21 of the monitoring node W3.

Next, the monitoring node W2 that receives respectively the trouble detection message T60 from the monitoring node W1 or the trouble detection message T50 from the monitoring node W3 causes the control unit 21 to generate random number smaller than the random number (i.e. “60”) that is included in the trouble detection message T60. Further, in a manner similar thereto, the control unit 21 generates random number smaller than the random number (i.e. “50”) that is included in the trouble detection message T50. In this case, it is provided that both of thus generated random numbers are “0”.

Next, as shown in FIG. 6A, respectively based on identification information of the monitoring nodes W1 itself that is included in the trouble detection message T60 and identification information of the monitoring nodes W3 itself that is included in the trouble detection message T50, the control unit 21 of the monitoring node W2 sends a trouble detection message T0 as the monitoring node W2 to the respective monitoring nodes W1 and W3. In the respective trouble detection messages T0 include information that they are trouble detection messages with respect to the monitoring node W2, identification information for identifying the monitored node BW itself where the trouble occurs, identification information for identifying the monitoring node W2 itself as a sending source, and the above-described random number “0” generated in the control unit 21 of the monitoring node W2. Here, when receiving the above-described trouble detection message T60 or T50, the control unit 21 of the monitoring node W2 ends monitoring the operating state of the monitored node BW.

Accordingly, the control unit 21 of the monitoring node W1 receiving the trouble detection messages T0 and T50 from the monitoring nodes W2 and W3 respectively compares values between the random number (i.e. “50” and “0”) that are included in respective trouble detection messages T0 and T50 and the random number (“60” included in the trouble detection message T60 and sent) that is memorized in the memory unit 22 of the monitoring node W1 when the own sends the trouble detection message T60. In the case of FIGS. 5 and 6, it is confirmed that the random number (“60”) which the monitoring node W1 itself includes in the trouble detection message T60 and sends is larger than the random number included in the other trouble message T50 or T0. Therefore, the control unit 21 of the monitoring node W1 generates a complement request message MP for requesting complement of the trouble occurred in the monitored node BW similarly to the first specific example and sends this to the corresponding node P similar to the first specific example that is previously recognized.

On the other hand, the control unit 21 of the monitoring nodes W3 receiving the trouble detection messages T60 and T0 respectively from the monitoring nodes W1 and W2 compares values between the random numbers (i.e. “60” and “0”) that are included in respective trouble detection messages T60 and T0 and the random number (“50” included in the trouble detection message T50 and sent) that is memorized in the memory unit 22 of the monitoring node W3 when the own sends the trouble detection message T50. In the case of FIGS. 5 and 6, it is confirmed that larger random number than the random number (“50”) which the monitoring node W3 itself includes in the trouble detection message T50 and sends is included in the other trouble message T60. Therefore, the control unit 21 of the monitoring node W3 ends the action as the control unit 21 without carrying out any continual action.

According to the second specific example, even if two monitoring nodes W1 and W3 detect trouble occurrence in the monitored node BW at the same time, the complement request message MP is sent to the corresponding node P only from the monitoring node W1. Here, detailed description is omitted because contents of the complementary request message MP itself and the action in the corresponding node P receiving it are similar to the above-described specific example.

### (C) Specific Action According to the First Embodiment

Next, in order to realize the above-described first specific example and the second specific example, specific action according to the first embodiment carried out in the monitoring node W, the monitored node BW and the corresponding node P respectively is described together using reference to FIGS. 7 and 8. Here, basically, the respective nodes 1 being the monitoring node W according to the first embodiment independently carry out the same action respectively. Further action shown in FIGS. 7 and 8 is regularly carried out as a part of main routine of the node 1 participating in the delivery system.

### (a) Specific Action in Monitoring Node

First, an action separately carried out in the node 1 being the monitoring nodes W1 to W3 is described using FIG. 7.

As shown in FIG. 7, as a sequence of above-described main routine, the control unit 21 of the node 1 being the monitoring nodes W1 to W3 is constantly waiting for the monitor request message from any node 1 being the monitored node BW (Step S1). When receiving the monitor request message (Step S1: YES), the control unit 21 first turns “OFF” the above-described trouble detection flag and monitoring end flag in the memory unit 22 for functioning as the monitoring node W (Step S2).

Next, the control unit 21 of the monitoring node W confirms whether or not the monitoring end flag is currently in a state of “ON” (Step S3). In a case of the state “ON” (Step S3: YES), the control unit 21 returns to the original main routine for acting as a normal node 1.

On the other hand, in a case where the monitoring end flag is not in the state “ON” according to the judgment of Step S3 (Step S3: NO), the control unit 21 sends the monitor message MW to the monitored node BW assigned to operating state monitor because the node 1 is to function as the monitoring node W (Step S4; Refer to FIG. 1). Subsequently, the control unit 21 confirms whether or not the response message RT in response to thus sent monitor message MW is sent from the monitored node BW (Step S5).

Then, when the response message RT is normally sent (Step S5: YES), the control unit 21 updates the identification information in the memory unit 22 by using the identification information (e.g. IP address) of the other monitoring node W included in the response message RT (Step S6). Subsequently, after the control unit 21 waits for a period preset as a period until the next monitor message MW is sent, the control unit 21 moves to the action of the Step S3 and repeats a sequence of the above-described action.

On the other hand, in the Step S5, when the response message RT is not normally sent from the monitored node BW, the control unit 21 of the monitoring node W judges that the above-described trouble occurs in the monitored node BW, and the control unit 21 turns “ON” the trouble detection flag.

Next, the control unit 21 generates the above-described random number (Step S9) and sends the above-described trouble detection message T including thus generated random number to the other monitoring node W (Step S10; Refer to FIG. 3B, 4A, 5B or 6A). Here, the trouble detection messages T60, T50, or T0 is are referred to as “trouble message T” as a generic term in the description below.

Subsequently, the control unit 21 waits for receipt of the trouble detection message T from the other monitoring node W for the preset waiting period (Step S11; Refer to FIG. 4A, 5B or 6A). Then the control unit 21 compares largeness between the random number (i.e. random number included in the trouble detection message T sent from the other monitoring node W) and the random number generated in the Step S9 and confirms whether or not the random number generated in the Step S9 is the largest (Step S12). In a case where the random number generated in the Step S9 is not the largest (Step S12: NO), the control unit 21 returns to the original main routine to act as a normal node 1.

On the contrary thereto, in a case where the random number generated in Step S9 is the largest (Step S12: YES), the control unit 21 sends the complement request message MP to the corresponding node P (Step S13; Refer to FIG. 4B or 6B), and then returns to the original main routine to act as a normal node 1.

Next, in the judgment of the Step S1, when the monitor request message is not received (Step S1: NO), the control unit 21 of the monitoring node W confirms whether or not the above-described trouble detection message T is sent from any other monitoring node W (Step S14; Refer to FIG. 3B, 4A, 5B or 6A). When the trouble detection message T is not also sent (Step S14: YES), the control unit 21 returns to the original main routine to act as a normal node 1.

On the contrary, when receiving the trouble detection message T (Step S14: YES), the control unit 21 confirms whether or not the above trouble detection flag is “ON” (Step S15). When the trouble detection flag is “ON” (Step S15: YES), the control unit 21 causes the memory unit 22 to memorize the random number included in the trouble detection message T sent in Step S14 (Step S16). Then the control unit 21 returns to the original main routine to act as a normal node 1.

On the other hand, in the judgment of Step S15, when the trouble detection flag is not on (Step S15: NO), the control unit 21 generates the random number in such manner that the random number is smaller than that included in the trouble detection message T received in the action of Step S14 and sends the trouble detection message T including thus generated random number to the other monitoring node W (Step S17; Refer to FIG. 4A, 5B, or 6A).

Subsequently, the control unit 21 turns the monitoring end flag “ON” (Step S18), and returns to the original main routine to act as a normal node 1.

### (b) Specific Action in Monitored Node

Next, an action carried out in a node 1 being the monitored node BW is described using FIGS. 8A and 8B.

As shown in FIG. 8A, for participating in the delivery system, the control unit 21 in the node 1 being the monitored node BW specifies, for example, three nodes among other nodes 1, as the monitoring node W, which already participated and to which monitoring in own operating state is committed. Then, the control unit 21 causes the memory unit 22 to memorize a monitoring node list including identification information for identifying them (Step S20). Here, as a method specifying the monitoring node W, for example, a method described in the above-described Patent Application No. 2007-245072 may be employed.

Next, the control unit 21 selects one monitoring node W from thus specified monitoring node list (Step S21), and sends the above-described monitor request message to thus selected monitoring node W (Step S22; Refer to Step 1 in FIG. 7).

Then the control unit 21 confirms whether or not it finishes sending the monitor request message to all the monitoring nodes W in the monitoring node list created in Step S20 (Step S23). Then when there exists the monitoring node W to which the monitor request message is not yet sent (Step S23: NO), the control unit 21 moves to the action of Step S21 for sending the monitor request message with respect to the monitoring node W.

On the other hand, in the judgment of Step S23, when the control unit 21 finishes sending the monitor request message with respect to all monitoring nodes W (Step S23: YES), the action described below is carried out to the respective monitoring nodes W (Step S24), and the control unit 21 returns to the main routine as the monitored node BW.

Next, an action of the above-described Step S24 is described in detail using FIG. 8B.

As an action of Step S24 carried out every monitoring node W in the monitored node BW, the control unit 21 of the monitored node BW first sends a monitor request message in the action of Step S22, and subsequently waits for the monitor message MW from the addressed monitoring node W, for predetermined period (Step S241). Then in a case where the monitor message MW is sent from any one of monitoring nodes W (Step S241: YES), the control unit 21 generates a corresponding response message RT and returns it to the monitoring node W sending the monitor message MW (Step S242; Refer to FIG. 1).

On the other hand, in the judgment of Step S241, when no monitor message is sent from the monitoring node W within the predetermined period (Step S241: NO), the control unit 21 judges that some trouble occurs in the monitoring node W and selects the other monitoring node W in the monitoring node list (Step S243). Then the control unit 21 sends the monitor request message to the monitoring node W newly selected (Step S244). The actions in the Steps S241 to 5244 described above are carried out in the control unit 21 of the monitored node BW every monitoring node W.

### (c) Specific Action in Corresponding Node

Finally, an action carried out in the node 1 being the corresponding node P is described using FIG. 8C.

As shown in FIG. 8C, the control unit 21 of the node 1 being the corresponding node P regularly monitors whether or not the above-described complement request message MP is sent from any one of monitoring nodes W in the delivery system (Step S25).

When the complement request message MP is not sent (Step S25: NO), the control unit 21 directly returns to the original main routine to act as a normal node 1.

On the contrary, in the judgment of Step S25, when the complement request message MP is sent from any one of the monitoring nodes W (Step S25: YES), the control unit 21 carries out necessary complementary actions based on the content (Step S26), and then returns to the original main routine to act as a normal node 1.

As described above, according to actions of the monitoring node W, the monitored node BW, and the corresponding node P of the first embodiment, when the response message RT including at least a list of a content ID indicative of contents is not sent from the monitored node BW to the monitoring node W, a replica of the content data indicated in the list thus memorized in the monitoring node W is created in any one of nodes 1. Therefore, when there is a possibility that some trouble occurs in the monitored node BW, the replica of the content data thus memorized in the monitored node BW is created in the other node 1 so that the number of the contents (inclusive of replica thereof) in the entire delivery system can be maintained for maintaining smooth delivery of the contents.

Accordingly, it is possible to maintain a good delivery condition of the contents in the delivery system without using, for example, a management server related to the entire delivery system.

Further, according to the first specific example related to the complement request message MP, when the response message RT is not sent from the monitored node BW, the control unit 21 searches a corresponding node P that memorizes the content data same as the content data memorized in the monitored node BW and sends to thus searched corresponding node P the complement request message MP that the replica of the content data is sent to the monitoring node W. Therefore, it is possible to restore the replica of the content data thus memorized in the monitored node BW within the monitoring node W.

Further, according to the second specific example related to the complement request message MP, when the response message RT is not sent from the monitored node BW, the control unit 21 searches the corresponding node P that memorizes the content data same as the content data memorized in the monitored node BW, and sends to the corresponding node P the complement request message MP that the replica of the content data is sent to any nodes 1 other than the monitoring node W, and the monitored node BW. Therefore it is possible to restore the replica of the content data memorized in the monitored node BW in the monitoring node W.

Further, according to the third specific example related to the complement request message MP, when no response message RT is sent from the monitored node BW, the control unit 21 selects any other node 1 and sends to thus selected node 1 the replica sending request for requesting to search the other node 1 memorizing the content data same as the content data memorized in the monitored node BW and acquire the replica of the content data from the other node 1. Therefore, it is possible to restore the replica of the content memorized in the monitored node BW in the selected node 1.

Further, when there is a possibility that some trouble occurs in the monitored node BW, the random number generated in the respective monitoring nodes W are mutually reciprocated among the plural monitoring nodes W monitoring the monitored node BW. Therefore, it is possible to effectively prevent excessive number of replicas in the entire delivery system.

### (III) Second Embodiment

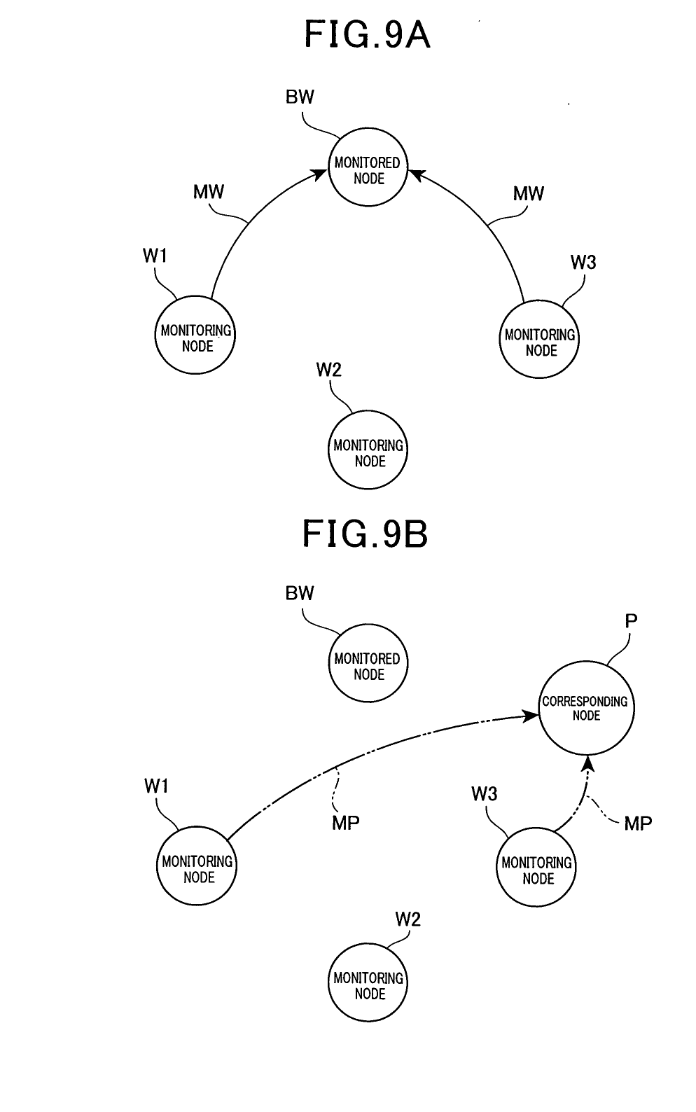

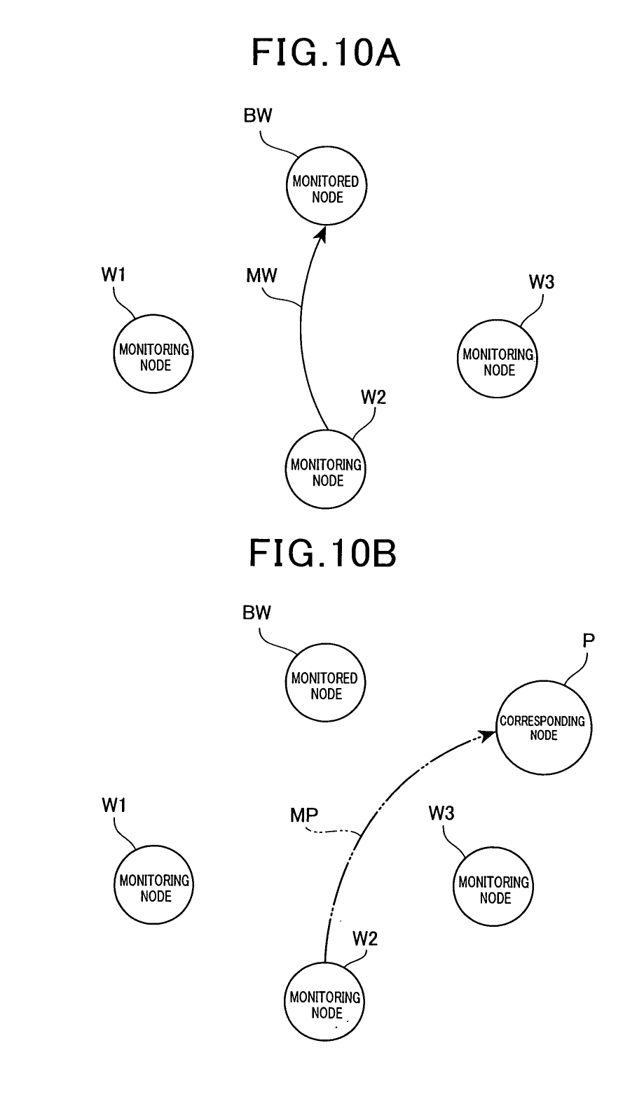

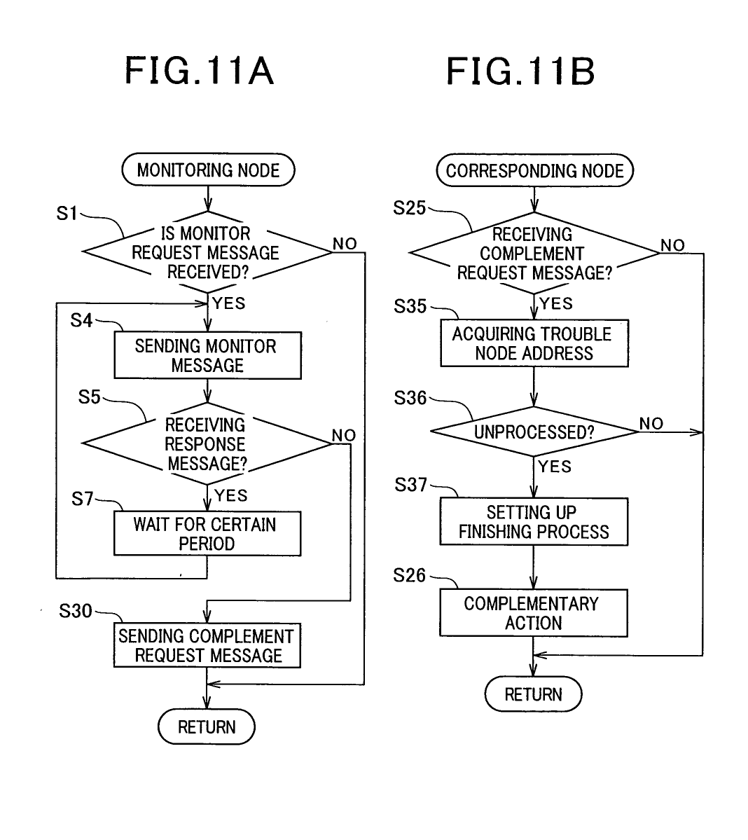

Next, a second embodiment being the other embodiment according to the present invention will be described using FIGS. 9 to 11. Here, FIGS. 9 and 10 are views exemplifying actions of respective monitoring nodes W, a monitored node BW, and a corresponding node P according to the second embodiment. FIG. 11 is a flowchart showing a specific action in the respective monitoring nodes W and the corresponding node P according to the second embodiment.

Here, the respective nodes according to the second embodiment basically include the same detail configuration and basically carry out the same detail action independently. Further the configuration of the node according to the second embodiment basically has the similar configuration to that of the node according to the first embodiment that is described basically using FIG. 2. Therefore, actions according to the second embodiment are described using a reference number similar to that of the first embodiment, with respect to the node configuration.

### (A) Specific Example of Second Embodiment

First, a specific example of an action according to the second embodiment in the respective nodes is exemplified and described using FIGS. 9 and 10.

In the second embodiment described below, an operating state of a single monitored node BW is monitored by three monitoring nodes W1 to W3, similarly to the case of the first embodiment. In a case where a trouble such as the above-described power off occurs in the single monitored node BW, all of three monitoring nodes W1 to W3 that monitor the operating state of the monitored node BM respectively send the above-described complement request message MP according to the first embodiment to the corresponding nodes P. Accordingly, the corresponding node P receiving the complement request message MP carries out a complementary action, for example similar to the first embodiment, only with respect to the complement request message MP that first reaches. According to the action related to the second embodiment, the complementary action itself is prevented from carrying out in duplication in the delivery system, in the case of trouble occurrence in the monitored node BW.

Here, in order to carry out the complementary action according to the second embodiment, it is necessary to specify only one corresponding node P being an address of the complement request message MP in all the monitoring nodes W. Further, because the response messages RT are different between the second embodiment and the first embodiment, identification information of the other monitoring node W monitoring the monitored node BW being the sending source becomes unnecessary. Further, it is not necessary that the monitoring node W according to the second embodiment memorizes the monitoring end flag, the trouble detection flag and the number list according to the first embodiment.

Next, as a specific example of the second embodiment, a case where all of three monitoring nodes W detect a trouble in the monitored node BW is described specifically using FIGS. 9 and 10.

First, as shown in FIG. 9A, it is provided that the respective monitoring nodes W1 to W3 separately and independently monitor the operating state of the monitored node BW in the above-described normal monitoring state, in a manner similar to the first embodiment.

Based on the fact that the response message RT to the monitor message MW sent respectively is not sent from the monitored node BW, respective control units 21 judge/recognize the trouble occurrence in the monitored node BW in the order of monitoring node W1, monitoring node W3, and monitoring node W2. This time difference of recognition depends on difference in time for the respective monitoring nodes W to send the monitor message MW. Here, the control unit 21 of the respective monitoring nodes W sends the complement request message MP similar to that of the first embodiment to the corresponding nodes P corresponding to identification information previously recognized in the order of monitoring node W1, monitoring node W3, and monitoring node W2.

Specifically, as shown in FIG. 9A, it is provided that the respective control units 21 first judge/recognize the trouble occurrence in the order of monitoring node W1 and monitoring node W3. Further, as shown in FIG. 9B, the control units 21 of the monitoring nodes W1 and W3 end monitoring the monitored node BW and then send the complement request message MP including the identification information of the monitored node BW to the corresponding node P in the order of monitoring node W1 and monitoring node W3 respectively.

Here, in a case where plural monitoring nodes W with different complement request messages MP are sent, the corresponding node P according to the second embodiment first compares the identification information of the monitored node BM which is included in them and confirms whether or not they are complement request messages MP with respect to the same monitored node BM. In a case where plural complement request messages MP with respect to the same monitored node BM are sent, the complementary action according to the first embodiment starts based only on contents of the complement request message MP that reaches the corresponding node P first. In case of FIG. 9, the complementary action according to the first embodiment starts based only on contents of the complement request message MP that is sent from the monitoring node W1 and first reaches the corresponding node P first.

Accordingly, as shown in FIGS. 10A and 10B, even though the monitoring node W2 recognizes the trouble occurrence in the monitored node BM and sends the complement request message MP to the corresponding node P at the last, the corresponding node P does not start the complementary action any longer.

Here, the complementary action carried by the corresponding node P according to the second embodiment is basically similar to that according to the first embodiment.

### (B) Specific Action According to Second Embodiment

Next, in order to realize the above-described specific examples together, a specific action according to the second embodiment carried out in the monitoring node W, and the corresponding node P respectively is described together using FIG. 11. Here, in the flowchart shown in FIG. 11, with respect to the same processes as those in the flowcharts shown in FIGS. 7 and 8, detail explanation is omitted by referring to the same Step number.

Further, basically the respective nodes 1 being the monitoring node W according to the second embodiment independently carry out the same action respectively. Further, the action shown in FIG. 11 is regularly carried out as a part of main routine of a node 1 participating in the delivery system. Further, because the specific action carried out in the monitored node BM according to the second embodiment is similar to that carried out in the monitored node BM according to the first embodiment, detail explanation is omitted.

### (a) Specific Action in Monitoring Node

First, an action separately carried out in the nodes 1 being the monitoring nodes W1 to W3 is described using FIG. 11A.

As shown in FIG. 11A, as a sequence of above-described main routine, the control unit 21 in the node 1 being the monitoring nodes W1 to W3 according to the second embodiment constantly carries out the similar processes to those of Steps S1, S4, S5 and S7 in the respective monitoring nodes W according to the first embodiment.

In the judgment of the Step S5, when the response message RT is not normally sent from the monitored node BW, the control unit 21 of the respective monitoring nodes W judges that the above-described trouble occurs and sends the above-described complement request message MP to the corresponding nodes P respectively (Step S30; Refer to FIG. 9B or 10B). Then the control unit 21 returns to the original main routine to act as a normal node 1.

### (b) Specific Action in Corresponding Node

Next, an action carried out in the node 1 being the corresponding node P according to the second embodiment is described using FIG. 11B. Here, the corresponding node P according to the second embodiment is different from the corresponding node P according to the first embodiment. With respect to the corresponding node P according to the second embodiment, unlike the corresponding node P according to the first embodiment, the corresponding node P memorizes already-complemented node list information that includes identification information of the monitored node BW subject to the complementary action in the past, in the memory unit 22 thereof.

As shown in FIG. 11B, the control unit 21 in the node 1 being the corresponding node P regularly monitors whether or not the above-described complement request message MP is sent from any one of monitoring nodes W in the delivery system (Step S25).

When the complement request message MP is not sent (Step S25: NO), the control unit 21 directly returns to the original main routine to act as a normal node 1.

On the other hand, in the judgment of Step S25, when the complement request message MP is sent from any one of the monitoring nodes W (Step S25: YES), the control unit 21 extracts identification information of the monitored node BM from thus sent complement request message MP (Step S35) and confirms whether or not it is the monitored node BM not yet subject to the complementary action (Step S36). The judgment in this Step S36 is carried out based on whether or not identification information of the monitored node BM is described in the above-described node list information thus already complemented. In a case where thus extracted identification information indicates the monitored node BM that is already subject to the complementary action (Step S36: NO), the control unit 21 returns to the original main routine to act as a normal node 1.

On the other hand, in the judgment of Step S36, in a case where thus extracted identification information indicates the monitored node BM that is not yet subject to the complementary action (Step S36: NO), the control unit 21 describes the identification information of the monitored node BM in the node list information thus already complemented (Step S37). Then the control unit 21 carries out the necessary complementary action in response to the contents of thus sent complement request message MP, similarly to the first embodiment (Step S26). Then the control unit 21 returns to the original main routine to act as a normal node 1.

As described above, according to actions of the monitoring node W, the monitored node BW, and the corresponding node P according to the second embodiment, when the response message RT including at least a list of a content ID indicative of contents is not sent from the monitored node BW to the monitoring node W, a replica of the content data indicated in the list thus memorized in the monitoring node W is created in any one of nodes 1. Therefore, when there is a possibility that some trouble occurs in the monitored node BW, the replica of the content data thus memorized in the monitored node BW is created in the other node 1 so that the number of the contents (inclusive of replica thereof) in the entire delivery system can be maintained for maintaining smooth delivery of the contents.

Accordingly, it is possible to maintain a good delivery condition of the contents in the delivery system without using, for example, a management server related to the entire delivery system.

Further, when there is a possibility that some trouble occurs in the monitored node BW, the complement request message MP is respectively sent to the corresponding node P from plural monitoring nodes W monitoring the monitored node BW, and the complementary action is carried out based on only a single complement request message MP among respective complement request messages MP received in the corresponding node P. Therefore, it is possible to effectively prevent excessive number of replicas in the entire delivery system by carrying out a replica of the contents based on only one complement request message MP.

Further, with respect to the same monitored node BW, replica of the contents is carried out based on only complement request message MP received first in the corresponding node P. Therefore, it is possible to effectively prevent excessive number of replicas in the entire delivery system.

Further, the respective embodiments described above are configured in such a manner that replica of the content data memorized in the memory unit 22 is generated in the memory unit 22 of the other node 1 when some trouble occurs in the monitored node BW.

Here, as a specific method of generating the replica, in a case where the node 1 assigns a role of supply source of the content data to the other node 1, the memory unit 22 in the node 1 generating the replica is divided into two regions: a delivery data memory region where content data the node 1 itself received is memorized and a replica memory region where replica of the content data memorized in the other node 1 is memorized. Here, although a total value of memory capacities of the delivery data memory region and the replica memory region may be preset, it is preferable that respective memory capacities may be freely changeable. With respect to the replica memory region of two above-described memory regions, it is preferable that content data memorized there is not deleted. In a case where the above-described total value possibly exceeds a value preset as the upper limit because the node 1 receives the content delivery, data is deleted in the chronological order among the content data memorized in the delivery data memory region.

On the other hand, in a case where the monitored node BW where the trouble once occurred and was eliminated is restored in the delivery system again, it is preferable that the node 1 being the monitored node BW is restored after all content data memorized in the replica memory region are deleted.

According to the configuration described above, it is not necessary to provide thing such as a content pool server for memorizing all content data in the delivery system because all the content data end up to be memorized in any one of the nodes 1 without fail.

Further, programs corresponding to the respective flowcharts shown in FIGS. 7 and 8 or FIG. 11 are recorded in an information recording medium such as a flexible disk or a hard disk or acquired and recorded through the interne or the like, they are read out with a general-purpose computer and executed, and the computer may be activated as the control unit 21 in the node 1 according the respective embodiments.

Thus described above, the present invention is applicable in the field of delivery system for delivering contents, particularly, if it is applied to the field of the delivery system of P2P type, especially remarkable effect is obtained.

The present invention is not confined to the configuration listed in the foregoing embodiments, but it is easily understood that the person skilled in the art can modify such configurations into various other modes, within the scope of the present invention described in the claims.

1. A network system including plural information processing devices mutually connected through a network,
the network system, comprising:
a monitored device which is one of the plural information processing devices which memorizes delivery information to be delivered to the plural information processing devices through the network, and
a monitoring device which is an information processing device other than the monitored device, and which monitors an operating state of the monitored device, wherein the monitored device comprises:
a responding device configured to return a response message including at least list information indicative of the delivery information memorized in the monitored device, to the monitoring device which has sent a monitor message, when the monitor message is sent from the monitoring device, and
the monitoring devices comprises:
a monitor message sending device configured to send the monitor message at a preset timing to the monitored device monitored by the monitoring device;
a list information memorizing device configured to extract the list information included in the response message from the response message, and memorize it, when the response message corresponding to the monitor message thus sent is returned from the monitored device; and
the network system comprises:
a replica creating device configured to create a replica of the delivery information indicated by the list information memorized in the list information memorizing device, in any one of the information processing devices, when the response message corresponding to the monitor message thus sent is not returned from the monitored device to the monitoring device.

2. The monitoring device included in the network system according to claim 1,
wherein the replica creating device is provided in the monitoring device, the replica creating device, comprising:
a searching device configured to search the information processing device including a delivery information memorizing device configured to memorize the delivery information indicated by the list information memorized in the list information memorizing device, when the response message corresponding to the monitor message thus sent is not returned from the monitored device; and
a replica sending request message sending device configured to send a replica sending request message requesting a replica of the delivery information memorized in the information processing device thus searched to be sent to the monitoring device, to thus searched information processing device.

3. The monitoring device included in the network system according to claim 1,
wherein the replica creating device is provided in the monitoring device, the replica creating device, comprising:
a searching device configured to search the information processing device including a delivery information memorizing device configured to memorize the delivery information indicated by the list information memorized in the list information memorizing device, when the response message corresponding to the monitor message thus sent is not returned from the monitored device; and
a replica sending request message sending device configured to send a replica sending request message requesting a replica of the delivery information memorized in the information processing device thus searched to be sent to the information processing device including the monitoring device, to the information processing device thus searched.

4. The monitoring device included in the network system according to claim 1,
wherein the replica creating device is provided in the monitoring device, the replica creating device, comprising:
a selecting device configured to select any one of the information processing devices including the monitoring device, when the response message corresponding to the monitor message thus sent is not returned from the monitored device; and
a replica sending request message sending device configured to send a replica sending request message requesting a replica of the delivery information indicated by the list information memorized in the list information memorizing device to be acquired, to the information processing device thus selected.

5. The monitoring device included in the network system according to claim 1, and comprising the replica creating device,
wherein the response message includes device identification information indicative of a monitoring device other than the monitoring device among a plurality of the monitoring devices which monitor the monitored device sending the response message, and the monitoring device, further comprises:
a first obtaining device configured to obtain priority information indicative of priority of the monitoring device among a plurality of the monitoring devices, and
a second obtaining device configured to obtain priority information of the other monitoring device, and
wherein the replica creating device creates a replica of the delivery information indicated by the list information memorized in the list information memorizing device, in any one of the information processing devices, when the priority of the monitoring device obtained by the first obtaining device is higher than the priority of the other monitoring device obtained by the second obtaining device.

6. The monitoring device included in the network system according to claim 1, and comprising the replica creating device,
wherein the response message includes device identification information indicative of the other monitoring device which monitors the monitored device sending the response message, and
the monitoring device, further comprises:
a number generating device configured to generate a number by a predetermined method, when the response message corresponding to the monitor message thus sent is not returned from the monitored device;
a number memorizing device configured to memorize the thus generated number;
a number sending device configured to send the thus generated number to the other monitoring devices and
a number returning device configured to generate a number smaller than the sent number, and return the number thus generated to the other monitoring device sending the number, when the number generated in any one of the other monitoring devices is sent from any one of the other monitoring devices, and
wherein the replica creating device creates a replica of the delivery information indicated by the list information memorized in the list information memorizing device, in any one of the information processing devices, when the respective numbers sent from the respective other monitoring devices are smaller than the number memorized in the number memorizing device.

7. The information processing device included in the network system according to claim 1, and comprising the replica creating device,
wherein each of the monitoring devices, further comprises:
a replica creation request message sending device configured to send a replica creation request message which requests for creating a replica of the delivery information indicated by the list information memorized in the list information memorizing device, and which includes at least device identification information for identifying the monitored device and the list information, to the information processing devices comprising the replica creating device, when the response message corresponding to the monitor message thus sent is not returned from the monitored device; and
the information processing device comprises:
a replica creation request message receiving device configured to respectively receive the replica creation request message from the respective monitoring devices; and
an extracting device configured to select one replica creation request message from the replica creation request message received from the respective monitoring devices, and respectively extract the device identification information and the list information included in the selected replica creation request message, and
wherein the replica creating device creates a replica of the delivery information indicated by the list information, in any one of information processing devices, based on the device identification information and the list information thus extracted.

8. The information processing device according to claim 7,
wherein the extracting device selects a replica creation request message received first, among the respective replica creation request messages received from the respective monitoring devices, and extracts the device identification information and the list information, respectively.

9. An information processing method in a network system comprising plural information processing devices mutually connected through a network,
wherein a step in a monitored device which is one information processing device which memorizes delivery information to be delivered to the information processing device through the network, comprises:
returning a response message including at least list information indicative of delivery information memorized in the monitored device, to a monitoring device which has sent a monitor message, when the monitor message is sent from the monitoring device which is an information processing device other than the monitored device, and monitors an operating state of the monitored device, and
wherein steps in the monitoring device, comprise:
sending the monitor message at a preset timing, to the monitored device monitored by the monitoring device; and
extracting the list information included in the response message from the response message, and memorizing it, when the response message corresponding to the monitor message thus sent is returned from the monitored device; and
a step in the monitoring device or the information processing device comprises:
creating a replica of the delivery information indicated by the list information thus memorized in the list information memorizing device, in any one of the information processing devices, when the response message corresponding to the monitor message thus sent is not returned from the monitored device to the monitoring device.

10. A computer-readable recording medium in which a program for a monitoring device is recorded,
the program causing a computer to function as a monitoring device according to claim 2.

11. A computer-readable recording medium in which a program for an information processing device is recorded,
the program causing a computer to function as an information processing device according to claim 7.

12. A computer-readable recording medium in which a program is recorded,
wherein the program is a program for a monitoring device included in a network system which includes plural information processing devices mutually connected through the network,
the network system, comprising:
a monitored device which is one of the plural information processing devices which memorizes delivery information to be delivered to the plural information processing devices through the network, and
a monitoring device which is an information processing device other than the monitored device, and which monitors an operating state of the monitored device, and
wherein the program for the monitoring device causes a computer for the monitoring device to perform the steps of:
sending a monitor message at a preset timing, to the monitored device monitored by the monitoring device,
wherein a response message corresponding to the monitor message thus sent includes at least list information indicative of delivery information memorized in the monitored device, extracting the list information included in the response message from the response message, and memorizing it, when the response message is returned from the monitored device; and
creating a replica of the delivery information indicated by the list information thus memorized in the list information memorizing device, in any one of the information processing devices, by the monitoring device or the information processing device, when the response message corresponding to the monitor message thus sent is not returned from the monitored device to the monitoring device.

13. A computer-readable recording medium in which a program for a monitoring device is recorded,
the program causing a computer to function as a monitoring device according to claim 3.

14. A computer-readable recording medium in which a program for a monitoring device is recorded,
the program causing a computer to function as a monitoring device according to claim 4.

15. A computer-readable recording medium in which a program for a monitoring device is recorded,
the program causing a computer to function as a monitoring device according to claim 5.

16. A computer-readable recording medium in which a program for a monitoring device is recorded,
the program causing a computer to function as a monitoring device according to claim 6.

17. A computer-readable recording medium in which a program for an information processing device is recorded,
the program causing a computer to function as an information processing device according to claim 8.
